(19) United States
(12) Patent Application Publication
(10) Pub. No.: US 2015/0201063 A1
(43) Pub. Date: Jul. 16, 2015

(54) METHOD AND APPARATUS FOR DATA PROCESSING

(71) Applicant: Samsung Electronics Co., Ltd., Gyeonggi-do (KR)

(72) Inventor: Su-Cheol CHEONG, Seoul (KR)

(21) Appl. No.: 14/593,129

(22) Filed: Jan. 9, 2015

(30) Foreign Application Priority Data
Jan. 10, 2014 (KR) 10-2014-0003563

(51) Int. Cl. H04M 1/725

(52) U.S. Cl. CPC H04M 1/72563

(57) ABSTRACT

A method is provided comprising: storing, in a first device, a first data item having an attribute; identifying, based on the attribute, a second device that is designated to receive the first data item; and transmitting at least a portion of the data item from the first device to the second device.

### CLAIM OF PRIORITY

This application claims priority under 35 U.S.C. §119(a) to an application filed in the Korean Intellectual Property Office on Jan. 10, 2014 and assigned Serial No. 10-2014-0003563, the entire contents of which are incorporated herein by reference.

### BACKGROUND

1. Technical Field

The present disclosure is related to electronic devices, and more particularly to a method and apparatus for data processing.

2. Description of the Related Art

With the advance of mobile communication techniques, electronic devices are provided in various forms such as a smart phone, a wearable device, a table Personal Computer (PC), and the like, and a variety of data can be transmitted and received via a communication system between the electronic devices. The electronic device may provide various functions such as a phone function, a message function, and an alarm function.

### SUMMARY

According to one aspect of the disclosure, a method is provided comprising: storing, in a first device, a first data item having an attribute; identifying, based on the attribute, a second device that is designated to receive the first data item; and transmitting at least a portion of the data item from the first device to the second device.

According to another aspect of the disclosure, an electronic device is provided, comprising a memory and a controller configured to: store, in the memory, a first data item having an attribute; identify, based on the attribute, a first device that is designated to receive the first data item; and transmit at least a portion of the data item to the first device.

### BRIEF DESCRIPTION OF THE DRAWINGS

The above and other aspects, features and advantages of certain aspects of the present disclosure will be more apparent from the following detailed description taken in conjunction with the accompanying drawings, in which:

FIG. 1 is a diagram of an example of a network environment 100, according to aspects of the disclosure;

FIG. 2 is a block diagram of an example of a data processing module, according to aspects of the disclosure;

FIG. 3 is a diagram of an example of a system, according to aspects of the disclosure;

FIG. 4 is a diagram of an example of a system, according to aspects of the disclosure;

FIG. 5A and FIG. 5B are diagrams illustrating an example of a system according to aspects of the disclosure;

FIG. 6 is a diagram of an example of a system according to aspects of the disclosure;

FIG. 7 is a diagram of an example of a system according to aspects of the disclosure;

FIG. 8A is a flowchart of an example of a process, according to aspects of the disclosure;

FIG. 8B is a flowchart of an example of a process, according to aspects of the disclosure;

FIG. 8C is a flowchart of an example of a process, according to aspects of the disclosure;

FIG. 9 is a flowchart of an example of a process, according to aspects of the disclosure;

FIG. 10 is a diagram of an example of an electronic device, according to aspects of the disclosure; and

FIG. 11 is a diagram of an example of a communications protocol, according to aspects of the disclosure.

### DETAILED DESCRIPTION

It should be understood that the present disclosure is not intended to limit the present disclosure to the particular examples disclosed therein, but, on the contrary, the present disclosure is intended to cover all modifications, equivalents, and alternatives falling within the spirit and scope of the present disclosure as defined by the appended claims. It should further be understood that like reference numerals denote like constitutional elements throughout the drawings. It should further be understood that the expression “or” includes any and all combinations of words enumerated together. For example, “A or B” may include either A or B, or both of A and B.

An electronic device according to various aspects of the disclosure of the present disclosure may be a device including a communication function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a MPEG-1 Audio Layer 3 (MP3) player, a mobile medical device, a camera, and a wearable device (e.g., a Head-Mounted-Device (HMD) such as electronic glasses, electronic clothes, an electronic bracelet, an electronic necklace, an electronic appcessory, an electronic tattoo, or a smart watch).

Additionally or alternatively, according to aspects of the disclosure, the electronic device may be a smart home appliance having a communication function. For example, the smart home appliance may include at least one of a TeleVision (TV), a Digital Video Disk (DVD) player, an audio, a refrigerator, an air conditioner, a cleaner, an oven, a microwave oven, a washing machine, an air purifier, a set-top box, a TV box (e.g., Samsung HomeSync™, Apple TV™, or Google TV™), a game console, an electronic dictionary, an electronic key, a camcorder, and an electronic picture frame.

Additionally or alternatively, according to aspects of the disclosure, the electronic device may include at least one of various medical devices (e.g., Magnetic Resonance Angiography (MRA), Magnetic Resonance Imaging (MRI), Computed Tomography (CT), imaging equipment, ultrasonic instrument, etc.), a navigation device, a Global Positioning System (GPS) receiver, an Event Data Recorder (EDR), a Flight Data Recorder (FDR), a car infotainment device, an electronic equipment for ship (e.g., a vessel navigation device, a gyro compass, etc.), avionics, a security device, and an industrial or domestic robot.

Additionally or alternatively, according to aspects of the disclosure, the electronic device may include at least one of a furniture or a part of building/constructions including a communication function, an electronic board, an electronic signature receiving device, a projector, and various measurement machines (e.g., water supply, electricity, gas, propagation measurement machine, etc.). In some aspects, the electronic device may be a combination of the aforementioned various devices. Stated succinctly, the disclosure is not limited to any specific type of electronic device. The term ‘user’ as used herein may refer to a person who uses the electronic device or another device which in some way controls the operation of the electronic device.

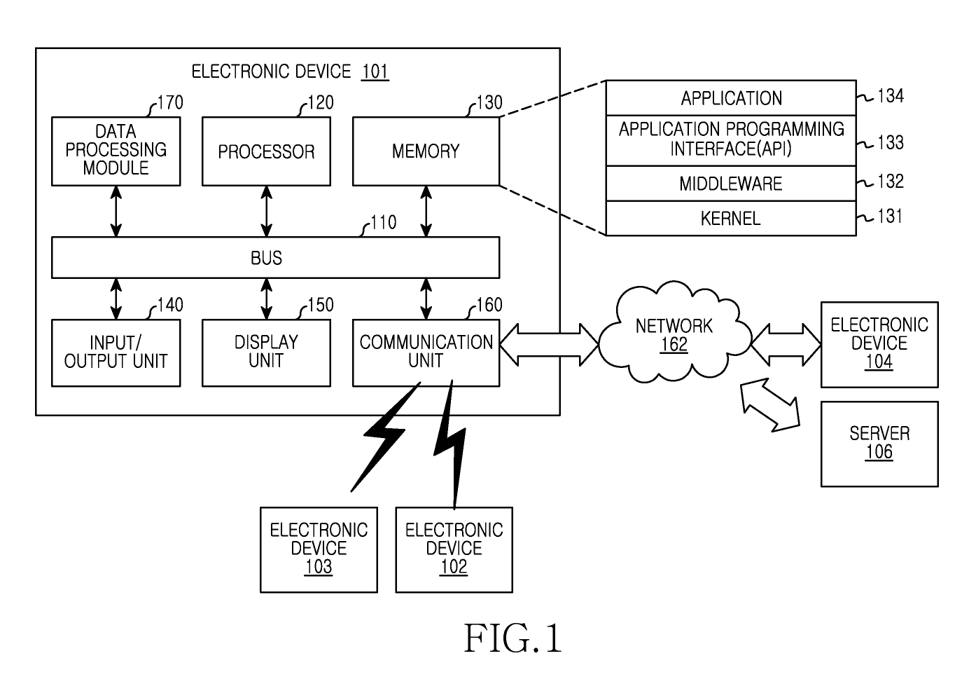

FIG. 1 is a diagram of an example of a network environment 100, according to aspects of the disclosure. The network environment 100 may include an electronic device 101 comprising a bus 110, a processor 120, a memory 130, an input/output interface 140, a display 150, a communication interface 160, and a data processing module 170.

The bus 110 may be a circuit for connecting the aforementioned constitutional elements to each other and for delivering a communication signal (e.g., a control message) between the aforementioned constitutional elements.

The processor 120 may include any suitable type of processing circuitry, such as a processor (e.g., an ARM-based processor), a Field Programmable Gate Array (FPGA), and an Application-Specific Integrated Circuit (ASIC). The processor 120 may receive an instruction from the aforementioned different constitutional elements (e.g., the memory 130, the input/output interface 140, the display 150, the communication interface 160, or the data processing module 170), for example, via the bus 110, and thus may interpret the received instruction and execute arithmetic or data processing according to the interpreted instruction.

The memory 130 may store an instruction or data received from the processor 120 or different constitutional elements (e.g., the input/output interface 140, the display 150, the communication interface 160, or the data processing module 170) or generated by the processor 120 or the different constitutional elements. The memory 130 may include programming modules such as a kernel 131, a middleware 132, an Application Programming Interface (API) 133, an application 134, and the like. Each of the aforementioned programming modules may consist of software, firmware, or hardware entities or may consist of at least two or more combinations thereof.

The kernel 131 may control or manage the remaining other programming modules, for example, system resources (e.g., the bus 110, the processor 120, the memory 130, etc.) used to execute an operation or function implemented in the middleware 132, the API 133, or the application 134. In addition, the kernel 131 may provide a controllable or manageable interface by accessing individual constitutional elements of the electronic device 101 in the middleware 132, the API 133, or the application 134.

The middleware 132 may perform a mediation role so that the API 133 or the application 134 communicates with the kernel 131 to exchange data. In addition, regarding task requests received from the application 134, for example, the middleware 132 may perform a control (e.g., scheduling or load balancing) for the task requests by using a method of assigning a priority capable of using a system resource (e.g., the bus 110, the processor 120, the memory 130, etc.) of the electronic device 101 to at least one of the applications 134.

The API 133 may include at least one interface or function (e.g., instruction) for file control, window control, video processing, character control, and the like, as an interface capable of controlling a function provided by the application 134 in the kernel 131 or the middleware 132.

According to various aspects, the application 134 may include a Short Message Service (SMS)/Multimedia Messaging Service (MMS) application, an e-mail application, a calendar application, an alarm application, a health care application (e.g., an application for measuring a physical activity level, a blood sugar, etc.) or an environment information application (e.g., atmospheric pressure, humidity, or temperature information). Additionally or alternatively, the application 134 may be an application related to an information exchange between the electronic device 101 and an external electronic device (e.g., an electronic device 102 or an electronic device 104). The application related to the information exchange may include, for example, a notification relay application for relaying specific information to the external electronic device or a device management application for managing the external electronic device.

For example, the notification relay application may include a function of relaying notification information generated in another application (e.g., an SMS/MMS application, an e-mail application, a health care application, an environment information application, etc.) of the electronic device 101 to the external electronic device (e.g., the electronic device 102 or the electronic device 104). Additionally or alternatively, the notification relay application may receive notification information, for example, from the external electronic device (e.g., the electronic device 102 or the electronic device 104) and may provide it to the user. The device management application may manage, for example, a function for at least one part of the external electronic device (e.g., the electronic device 102 or the electronic device 104) which communicates with the electronic device 101. Examples of the function include turning on/turning off the external electronic device itself (or some components thereof) or adjusting a display illumination (or a resolution), and managing (e.g., installing, deleting, or updating) of an application which operates in the external electronic device or a service (e.g., a call service or a message service) provided by the external electronic device.

According to various aspects, the application 134 may include an application specified according to attribute information (e.g., an electronic device type) of the external electronic device (e.g., the electronic device 102 or the electronic device 104). For example, if the external electronic device is an MP3 player, the application 134 may include an application related to a music play. Similarly, if the external electronic device is a mobile medical device, the application 134 may include an application related to a health care. According to aspects of the disclosure, the application 134 may include at least one of a specified application in the electronic device 101 or an application received from the external electronic device (e.g., a server 106, the electronic device 102, or the electronic device 104).

The input/output interface 140 may relay an instruction or data input from a user via a sensor (e.g., an acceleration sensor, a gyro sensor) or an input/output device (e.g., a keyboard, or a touch screen) to the processor 120, the memory 130, the communication interface 160, or the data processing module 170, for example, via the bus 110. For example, the input/output interface 140 may provide data regarding a user's touch input via the touch screen to the processor 120. In addition, the input/output interface 140 may output an instruction or data received from the processor 120, the memory 130, the communication interface 160, or the data processing module 170 to an output device (e.g., a speaker or a display), for example, via the bus 110. For example, the input/output interface 140 may output audio data provided by using the processor 120 to the user via the speaker.

The display 150 may display a variety of information (e.g., multimedia data or text data) to the user.

The communication interface 160 may connect a communication between the electronic device 101 and an external device (e.g., the electronic device 102, the electronic device 104, or the server 106). For example, the communication interface 160 may support a network communication 162 (e.g., Internet, Local Area Network (LAN), Wide Area Network (WAN), telecommunication network, cellular network, satellite network, Plain Old Telephone Service (POTS), etc.) and a near distance communication 164 (e.g., Wireless Fidelity (WiFi), Bluetooth (BT), Near Field Communication (NFC), or wired communication (e.g., Universal Serial Bus (USB), High Definition Multimedia Interface (HDMI), Recommended Standard (RS)-232, POTS, etc.). According to aspects of the disclosure, a protocol for a communication between the electronic device 101 and the external device (e.g., a near distance communication protocol, a network communication protocol, or a wired communication protocol) may be supported in at least one of the API 133 and the middleware 132. Each of the electronic devices 102 and 104 may be a device which is the same (e.g., the same type) as the electronic device 101 or may be a different (e.g., a different type) device.

The data processing module 170 may process at least a portion of information acquired from different constitutional elements (e.g., the processor 120, the memory 130, the input/output interface 140, or the communication interface 160), and may provide this to the user in various manners. For example, the data processing module 170 may control at least a part of functions of the electronic device 101 so that the electronic device 101 interworks with another electronic device (e.g., the electronic device 102, the electronic device 104, or the server 106) either by the use of the processor 120 or independently.

The data processing module 170 may connect a first electronic device with a second electronic device and a third electronic device through a near distance communication, may determine first data to be transmitted to the second electronic device and/or second data to be transmitted to the third electronic device based on state information of the second electronic device and state information of the third electronic device, and may transmit the determined first data to the second electronic device and/or transmit the second data to the third electronic device.

The data processing module 170 may connect the first electronic device with the second electronic device and the third electronic device through the near distance communication, may determine not to transmit data designated to be transmitted to the second electronic device based on first state information of the second electronic device, and may transmit designated data to the third electronic device based on second state information of the third electronic device.

The data processing module 170 may split data so that the data displayed to one screen in the first electronic device is displayed by using a plurality of screens of the second electronic device and the third electronic device, and may transmit the split data to the second electronic device and the third electronic device. In doing so, instead of one electronic device (e.g., the first electronic device), two electronic devices (e.g., the second and third electronic devices) may be used to use the data (e.g., to display the data).

The data processing module 170 may receive state information including one or more of battery remaining amount information of the second electronic device or the third electronic device, activation information, priority information, classification group information, connection state information of a near distance communication with the first electronic device, and data processing amount information.

The data processing module 170 may distinguish second data or third data according to an attribute of data received by the first electronic device. The data processing module 170 may determine an attribute by using two or more groups including one or more of call reception information, missing call information, received text message information, received e-mail information, received SNS message information, media information, alarm information, and a data type.

The data processing module 170 may confirm a connection of the designated second electronic device and the designated third electronic device among a plurality of electronic devices designated to transmit one or more pieces of data received by the first electronic device from a fourth electronic device.

The data processing module 170 may perform a near distance wireless communication by using at least any one of a WiFi communication, a BT communication, an NFC communication, a ZigBee communication, an IrDA communication, and the like.

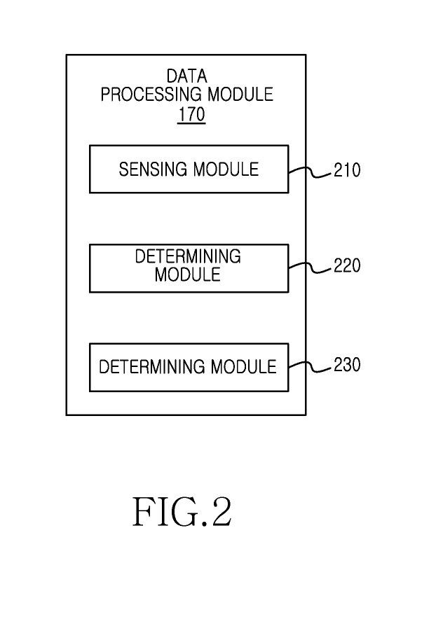

The data processing module 170 may determine not to transmit designated data if one or more pieces of numeric information included in first state information does not satisfy designated numeric information. In some implementations, the data processing module 170 may operate under the control of the processor 120. Thus, at least some of the operations discussed with respect to FIGS. 2-9, below, may be performed by the data processing module 170 and/or the processor 120.

FIG. 2 is a block diagram of an example of the data processing module 170 of the electronic device (e.g., the electronic device 101), according to various aspects of the disclosure. Referring to FIG. 2, the data processing module 170 may include a sensing module 210, a determining module 220, and a providing module 230.

The sensing module 210 may sense one or more pieces of data of a designated attribute received by the electronic device 101 through a network communication. The data of the designated attribute may be determined as an attribute of data using one or more of text data, image data, and sound data among data used by the electronic device 101, or may be information designated for a purpose of using data by a user. The sensing module 210 may sense one or more electronic devices connected through the network communication.

The determining module 220 may determine different electronic devices connected through the network communication with the electronic device 101 for transmitting designated data. If media data including a screen configuration displayed to the display module 150 of the electronic device 101 is transmitted to two or more different electronic devices, the determining module 220 may split the screen configuration of the media data such that two or more display modules of the different electronic devices can be displayed as if they are one display module, and may determine the split media data to be transmitted to each of the different electronic devices.

The providing module 230 may transmit designated data to a different electronic device which is configured to transmit the designated data by referring to configuration information of the electronic device 101. If it is confirmed that two or more different electronic devices are connected to the electronic device 101 through the network communication, the providing module 230 may provide the designated data so that the data is transmitted to a designated different electronic device.

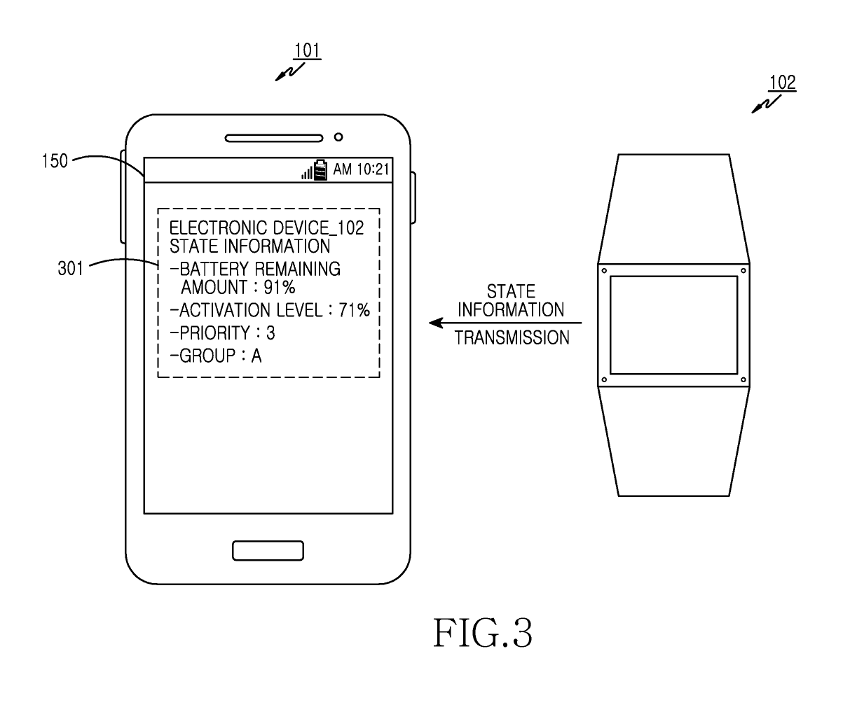

FIG. 3 is a diagram of an example of a system, according to aspects of the disclosure. As illustrated, the system includes the electronic device 101 and a second electronic device 102. The electronic device 102 may be a smartwatch, and/or any other suitable type of electronic device.

The electronic device 101 may determine an attribute of data to be transmitted to the second electronic device 102 and/or an attribute of data to be transmitted to the third electronic device 103 by referring to state information of the second electronic device 102 or third electronic device 103 connected through a network communication. According to one exemplary embodiment, the electronic device 101 may be connected to the second electronic device 102 through one or more network communications (e.g., a near distance wireless communication or a near distance communication), and may receive state information 301 of the second electronic device 102 from the second electronic device 102. The state information 301 received from the second electronic device may include one or more of battery remaining amount information of the second electronic device, activation information, priority information, classification group information, connection state information of a near distance communication with the first electronic device, and data processing amount information.

The electronic device 101 may associate different data item attributes, with respective remote devices. An example of a data item attribute may be the type of data item. Examples of different data item types may include, The aforementioned data attribute may be determined using two or more groups including one or more of call reception information, missing call information, text message, e-mail, SNS message, media, alarm, etc. The associations between data item attribute(s) and respective remote devices, may be saved in any suitable type of data structure or server, such as a record stored in the memory of the electronic device 101 or a database.

In operation, the electronic device 101 may select a data item stored in the memory of the electronic device 101 for transmission to a remote device (e.g., the electronic device 102). Next, the electronic device 101 may identify an attribute of the data item. For example, the electronic device may determine whether the data item is a text message, an email, or another type of data item. Next, the electronic device 101 may identify a remote device (e.g., the electronic device 102), that is associated with the data item attribute. Next, the electronic device 101 may determine whether to transmit the data item to the identified remote device (e.g., the electronic device 102) based on state information of the identified electronic device. For example, if the battery level of the identified electronic device (e.g., the electronic device 102) is greater than a threshold, the electronic device 101 may transmit the data item to the remote device. Otherwise, if the battery level is less than the threshold, the electronic device 101 may refrain from transmitting the data item to the identified remote device (e.g., the electronic device 102).

The electronic device 101 may determine an attribute of data to be transmitted to the second electronic device based on the state information 301 received from the second electronic device and configuration information configured in the electronic device 101. According to one exemplary embodiment, the electronic device 101 may classify data received from one or more different electronic devices or data stored in the memory of the electronic device 101 according to one or more data attributes and then may store the data in a database. The electronic device 101 may refer to the database to transmit data received from one or more different electronic devices or designated data stored in the memory of the electronic device 101 so that the data is displayed to the second electronic device 102, in association with a data attribute configured in association with the second electronic device connected to the electronic device 101 through the network communication. The electronic device 101 may transmit data so that data transmitted to the second electronic device is output to the second electronic device, and may transmit address information capable of accessing corresponding data.

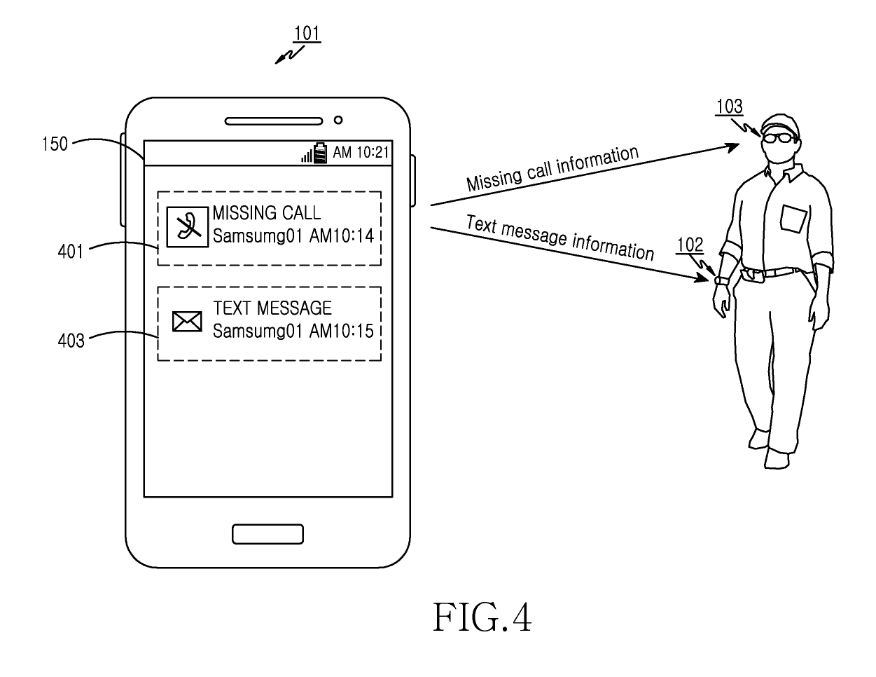

FIG. 4 is a diagram of an example of a system, according to aspects of the disclosure. As illustrated, the system includes the electronic device 101, the second electronic device 102, and a third electronic device 103. As illustrated, the third electronic device 103 may be a head-mounted display and/or any other suitable type of wearable and/or non-wearable device.

When two or more electronic devices (e.g., the second electronic device 102 and the third electronic device 103) are connected through a network communication, the electronic device 101 may transmit one or more pieces of data received by the electronic device 101 and data executed by the electronic device 101 to the designated second electronic device 102 or the designated third electronic device 103. According to one exemplary embodiment, in operation, the electronic device 101 may connect to the electronic device 102 and the electronic device 103. As noted, the electronic device 101 may connect to the electronic device 102 and the electronic device 103 by using any suitable type of communications protocol. Next, confirm one or more of the second electronic device 102 (e.g., the electronic device 102 which is worn like a wrist watch) and the third electronic device 103 (e.g., the electronic device 103 which is worn like glasses) connected through the network communication. The electronic device 101 may determine a data attribute (e.g., text information) to be transmitted to the second electronic device 102 and a data attribute (e.g., voice information) to be transmitted to the third electronic device 103 based on state information received by the second electronic device 102 determine that the electronic device 102 is associated with a first data attribute (e.g., type) and the electronic device 103 is associated with a second data attribute (e.g., type). For example, the electronic device 101 may determine that the electronic device 102 is designated to receive text data from the electronic device 101. In addition, the electronic device 101 may determine that the electronic device 103 is designated to receive voice data from the electronic device 101.

Afterwards, the electronic device may transmit one or more data items from the first type to the second device 102 and one or more data items from the second type to the third device 103. For example, the electronic device 101 may transmit a missed call notification 401 to information at a failure of receiving a call from ‘Samsung01’, and may transmit it to the third electronic device 103 designated to transmit data of a corresponding attribute (e.g., text information). The electronic device 101 may receive and a text message 403 from ‘Samsuing01’, and may transmit it to the second electronic device 102 designated to transmit data of a corresponding attribute (e.g., voice information). In some implementations, the electronic device 101 may transmit to the second electronic device 102 and the third electronic device 103 data items that are currently displayed on the display screen of the electronic device 101. In some implementations, each data item may be transmitted to a respective one of the electronic device 102 and 103 when that data item is generated and/or received at the first electronic device 101. Thus, in such implementations, the electronic device 101 may automatically forward information received and/or generated at the electronic device 101 to the electronic devices 102 and 103.

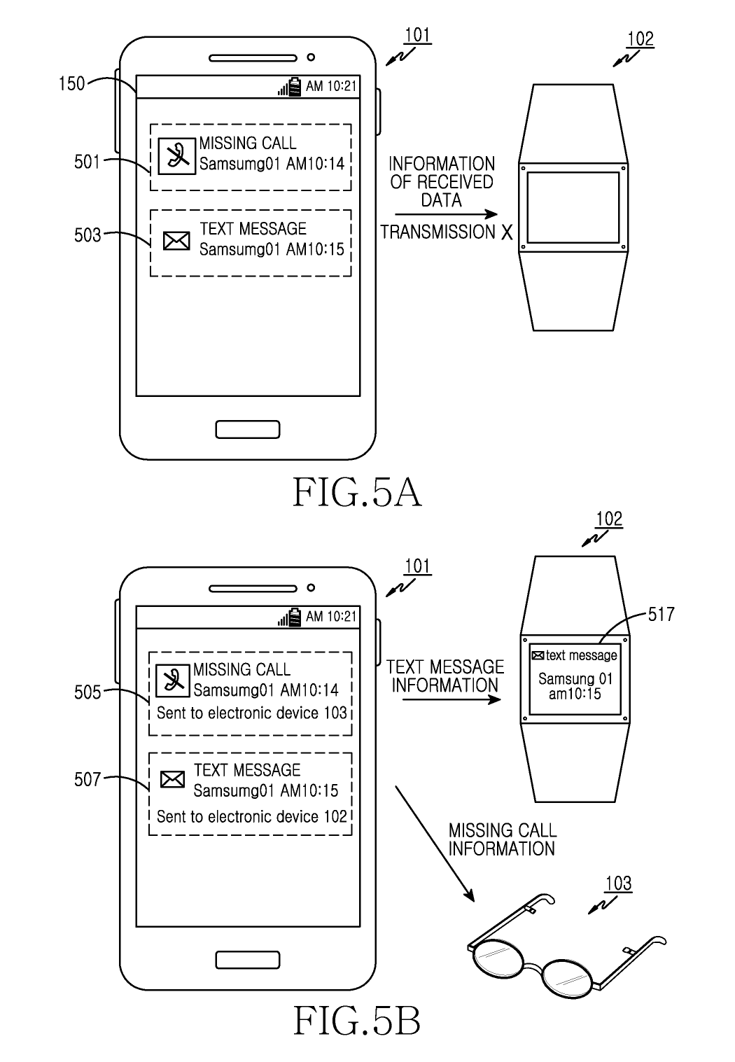

FIGS. 5A and 5B are diagrams illustrating an example of a system according to aspects of the disclosure. The system includes the electronic device 101 and one or more the second electronic device 102 and the third electronic device 103. The electronic device 101 can be connected to any of the second electronic device 102 and the third device 103. In some implementations, the electronic device 101 may forward information (or a specific type of information) to the second electronic device only when the electronic device 101 is connected to a predetermined number of devices.

For example, the electronic device 101 may forward information to the second electronic device 102 only when the electronic device is connected to at least two devices at the same time. Thus, when the electronic device 101 is only connected to the second electronic device 102, the electronic device 101 may refrain from transmitting information to the second electronic device 102. By contrast, when the electronic device is connected to both the second electronic device 102 and the third electronic device 103, the electronic device 101 may forward information to the electronic device 102. Alternatively, the electronic device 101 may be in a state of being connected to only one of the second electronic device 102 and the third electronic device 103 through a network communication, and only in case of being connected to two or more different electronic devices (e.g., the second electronic device 102 and the third electronic device 103), may transmit received data to a designated electronic device (e.g., the second electronic device 102 or the third electronic device 103).

Referring to FIG. 5A, the electronic device 101 may a text message 503 designated to be transmitted to the second electronic device 102 and a missed call notification 501 designated to be transmitted to the third electronic device 103. Next, the electronic device 101 may detect that it is connected to the second electronic device 102. Next, in a state of being connected to the second electronic device through the network communication, the electronic device 101 may search for one or more electronic devices connected through the network communication, and may confirm the connected second electronic device 102. The electronic device 101 may determine that the number of electronic devices that are connected to electronic device 101 is not greater than or equal to 2, and may refrain from transmitting the received text message 503 to the second electronic device 102.

By contrast, as shown in FIG. 5B, when the electronic device 101 is connected to two or more other devices, the electronic device may transmit the received text message 503 to the second electronic device 102. In addition the electronic device 101, upon confirmation of being connected to the third electronic device through the network communication, and may transmit s received missed call notification to the third electronic device 103.

According to the aforementioned explanation, when a user confirms a generated event (e.g., a ‘text message’ or data such as ‘call connection request information’), an operational procedure can be simplified as transmitting it to an electronic device capable of interworking therewith. In some implementations, upon reception of a ‘call connection request information’ from a different electronic device (e.g., a fourth electronic device), the electronic device 101 may forward the request to the third electronic device 103 which includes a microphone and a speaker, so as to permit the user to establish a call connection with the fourth electronic device via the third electronic device 103.

According to various aspects, the electronic device 101 may change and configure an attribute of data transmitted to the connected electronic devices. According to aspects of the disclosure, if the electronic device 101 confirms that the electronic device 101 is connected to the second electronic device 102 and the third electronic device 103, the second electronic device 102 may be configured to transmit data related to a ‘text (e.g., a ‘text message’ or an ‘e-mail’)’, and the third electronic device 103 may be configured to transmit data related to a ‘telephone communication’. If the electronic device 101 confirms that the electronic device 101 is connected to the second electronic device 102 and the fourth electronic device (not shown), the second electronic device 102 may be configured to transmit data related to a ‘text message’, the third electronic device 103 may be configured to transmit data related to a ‘telephone communication’, and the fourth electronic device (not shown) may be configured to transmit data related to an ‘e-mail’.

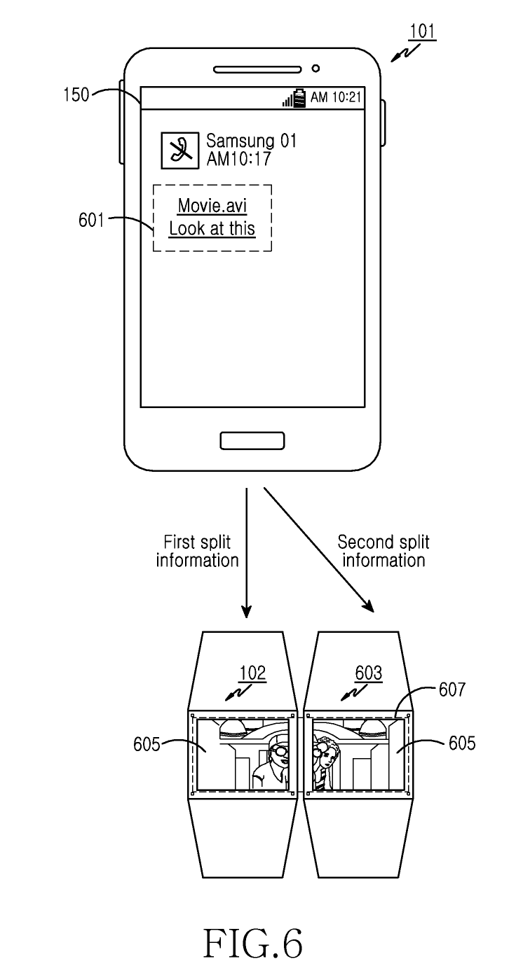

FIG. 6 is a diagram of an example of a system according to aspects of the disclosure. As illustrated, in this example, the system includes the electronic device 101, the electronic device 102, and an electronic device 603. The electronic device 603 may be a smart watch and or any other suitable type of wearable and non-wearable electronic device.

In operation, the electronic device 101 may receive media data that can be reproduced in the display module 150 or address information capable of connecting with media data from the fourth electronic device. If it is detected that two or more designated electronic devices (e.g., the second electronic device 102 and the third electronic device 603) are connected through a network communication the electronic device 101 is connected to a first plurality of other devices, the electronic device 101 may control the connected second electronic device 102 and third electronic device 603 to perform the operation electronic device may divide the media data into a second plurality of data portions and transmit to each one of the first plurality of other devices a different one from the second plurality of data portions.

For example, the electronic device 101 may receive ‘movie.avi 601’ data from ‘Samsung01’. Next, the electronic device 101 may detect that it is connected to the electronic device 102 and the electronic device 603. Next, the electronic device 101 may divide (or separate) a screen configuration displayed when the ‘movie.avi 601’ data is executed into data for reproducing a left designated region and data for reproducing a right designated region each frame in the data 601 into a left portion and a right portion. Next, the electronic device 101 may transmit the left portion of each frame to the electronic device 102 and the right portion of each frame to the electronic device 603. In some implementations, the electronic device 101 may select the electronic device 102 to receive the left portion of each frame based on a designation stored in a database. Similarly, the electronic device 101 may select the electronic device 603 to receive the right portion of each frame based on a designation stored in a database. For example, a frame 607 from the data 601 may be divided into a right portion 605 and a left portion 605. Afterwards, the right portion 605 may be transmitted to the electronic device 603 while the left portion 606 is transmitted to the electronic device 102. As illustrated in FIG. 6, transmitting different portions of a given frame to devices 102 and 603 permits the devices 102 and 603 to compound each other to form a single screen.

Although in this example the data 601 is a video file, in other examples any other suitable type of data may be used. Furthermore, although in this example the data 601 is divided on a per-frame basis, in other examples the data 601 may be divided in any other suitable manner. Stated succinctly, the present disclosure is not limited to dividing any specific type of data and/or any specific manner of dividing the data.

According to information configured in a database, the electronic device 101 may transmit the data for reproducing the divided left designated region so that it is produced in the display module 605 of the second electronic device 102, and may transmit the data for reproducing the right designated region so that it is reproduced in the display module 605 of the third electronic device 603. The electronic device 101 may transmit the ‘movei.avi 601’ data divided such that the display modules of two electronic devices (e.g., the second electronic device 102 and the third electronic device 603) are used as if they are one screen. The second electronic device 102 and the third electronic device 603 may reproduce data received from the electronic device 101 through each display module (e.g., the display module 605 of the second electronic device 102 and the display module 605 of the third electronic device 603) as if they are one screen 607.

The electronic device 101 is not limited to an operation in which data is transmitted in such a manner that one piece of media data (e.g., ‘movie.avi’) is reproduced by configuring a screen as if display modules (e.g., the display module 605 and the display module 605) of two electronic devices (e.g., the second electronic device 102 and the third display device 603) are one display module. Rather, data may be divided in transmission by configuring a screen as if displays included in three or more electronic devices (e.g., the second electronic device 102, the third electronic device 603, and the fourth electronic device) are one display.

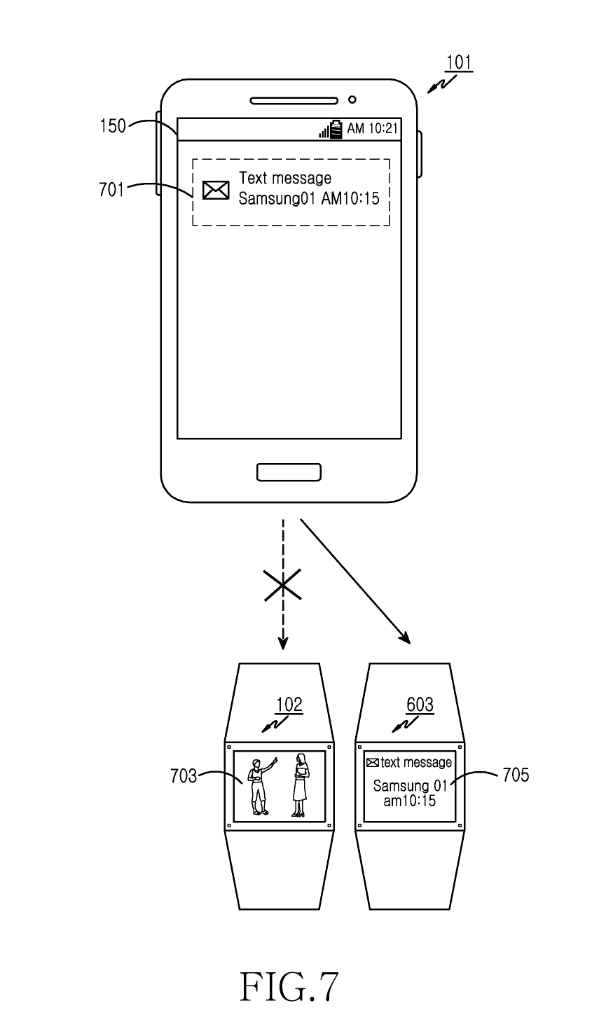

FIG. 7 is a diagram of an example of a system, according to aspects of the disclosure. As illustrated, in this example, the system includes the electronic device 101, the electronic device 102, and an electronic device 603.

The electronic device 101 may refer to a database to transmit one or more pieces of data received from the electronic device 101 to the connected second electronic device 102 or third electronic device 603. In operation, the electronic device may receive or store in memory a text message 701. Next, the electronic device 101 may receive state information of each electronic device from the connected second electronic device 102 and third electronic device 603, and may refer to the state information to change an electronic device for receiving designated data identify one or more connections with other devices. For example, the electronic device 101 may detect that it is connected with the second electronic device 102 and the third electronic device 603 through the network communication. If the electronic device 101 determines that two or more electronic devices including the second electronic device 102 are connected through the network communication, designated configuration information may be included in the database so that a received ‘text message 701’ is transmitted to the second electronic device 102. Next, the electronic device 101 may detect that the electronic device 102 is designated to receive text messages based on a record stored in the memory of the electronic device 101. Next, the electronic device 101 may refer to state information received from the second electronic device 102 to determine whether to transmit the ‘text message 701’ to the designated electronic device 102. If the electronic device 102 is in a first state, the electronic device 101 may transmit the text message 701 to the electronic device 102. By contrast, if the electronic device 102 is in a second state, the electronic device 101 may transmit the text message 701 to the electronic device 603.

For example, the electronic device 101 may refer to the state information received from the second electronic device 102 to detect that a motion picture is being reproduced in the display module 703 of the second electronic device 102, and may determine another electronic device capable of displaying the received ‘text message 701’ according to the configuration information included in the database. The electronic device 101 may refer to priority information of an electronic device for transmitting the text message included in the database to select the electronic device 603 as an alternative recipient of the text message 701. The electronic device 101 may transmit data of the ‘text message 701’ to the electronic device 603 so that the received ‘text message 701’ is displayed to the display module 705 of the electronic device 603.

As another example, the electronic device 101 may include configuration information for transmitting e-mail data(not shown), which is received while the electronic device 101 is connected to the electronic device 102 and the electronic device 603. Upon detecting the configuration information designates the electronic device 102 as a recipient of the e-mail data, the electronic device 101 may determine whether to transmit the e-mail data to the electronic device 102 based on state information received from the electronic device 102. For example, the electronic device 101 may obtain an indication of a remaining battery charge of the electronic device's 102. When the remaining battery charge is above a predetermined threshold, the electronic device 101 may transmit the email data to the electronic device 102. Otherwise, when the remaining battery charge is below the threshold, the electronic device 101 may transmit the email data to the electronic device 603. If the battery remaining amount information of the second electronic device 102 is less than or equal to a designated battery remaining amount, may transmit the ‘e-mail (not shown)’ data to the third electronic device 603 having a next priority. According to another aspect of the disclosure, the electronic device 101 may provide control such that designated data is transmitted to another electronic device (not shown) having a next priority if a data processing amount (or load) of the second electronic device 102 is greater than or equal to a designated numeric value based on the state information included in the second electronic device 102.

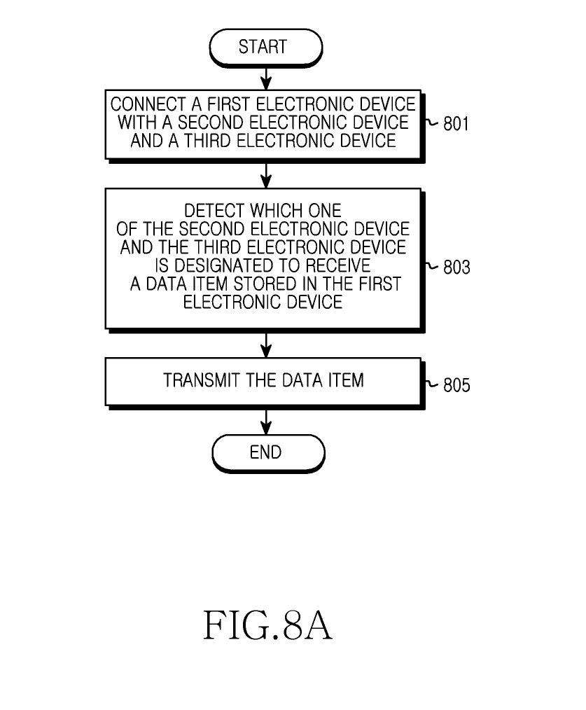

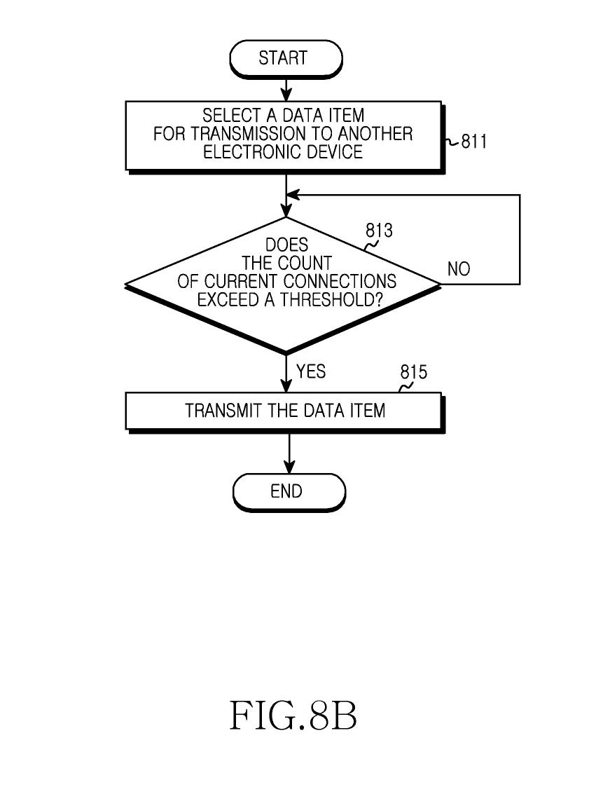

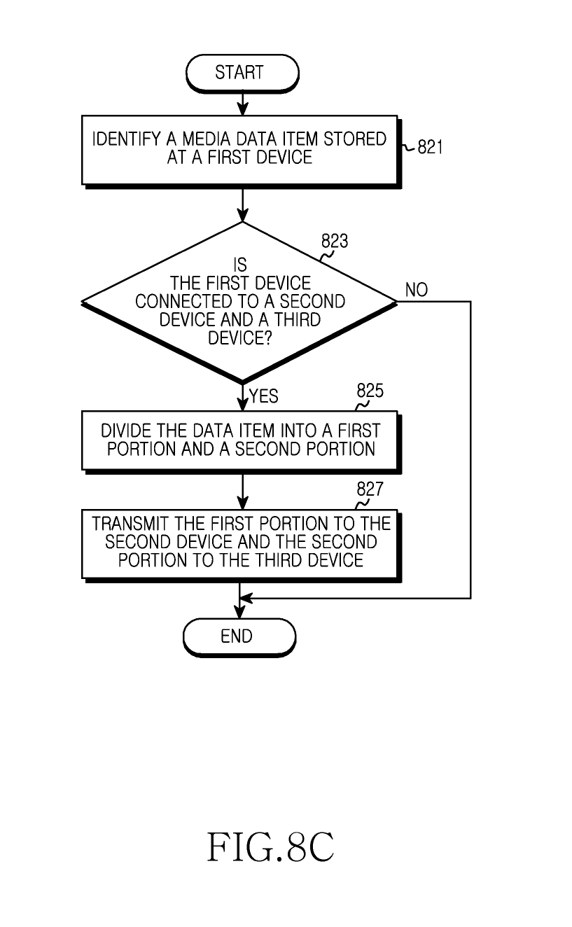

FIG. 8A is a flowchart of an example of a process, according to aspects of the disclosure. In operation 801, the first electronic device 101 may connect with a second electronic device 102 and third electronic device 103. In operation 803, the electronic device 101 detects which one of the first electronic device and the second electronic device is designated to receive a data item from a first type (e.g., a text message). In this example, the electronic device detects that the second electronic device is designated to receive the data item. In operation 805, the first electronic device 101 may perform transmission to an electronic device (e.g., the second electronic device 102 and/or the third electronic device 103) configured to transmit designated data device 101 transmits the data item to the second electronic device 102. The data transmitted by the electronic device 101 to the second electronic device 102 and/or the third electronic device 103 may be data item may be any suitable type of data item, such as (e.g., it may be one or more of data including a variety of information such as a ‘text message’, ‘call reception information’, ‘missed call information’, and ‘e-mail’. The data item may be received at the first electronic device from a fourth electronic device (not shown) through the network communication, and may be transmitted to the second electronic device 102 and/or third electronic device 103 designated in configuration information according to a data attribute via a network connection, and/or any other suitable type of connection.

FIG. 8B is a flowchart of an example of a process, according to aspects of the disclosure. In operation 811, the first electronic device 101 may refer to configuration information to determine the second electronic device 102 for transmitting designated data. The data configured by the electronic device 101 to be transmitted to the second electronic device 102 may be data of a designated attribute received by the electronic device 101 through the network communication, or may be data of a designated attribute stored in the memory 130 of the electronic device 101. For example, the data of the designated attribute may be data included in one of a plurality of groups divided into two or more attributes including one or more of data consisting of a text used in the electronic device 101, data including a sound, and data including an image.

In operation 813, the first electronic device 101 may connect with the designated second electronic device 102 and third electronic device 103 through the network communication. The operation of connecting the first electronic device 101 with the second electronic device 102 and the third electronic device 103 through the network communication may be an operation of confirming a connection state. The first electronic device 101 may confirm a state of being connected through the network communication with two or more electronic devices including the designated electronic device (e.g., the second electronic device 102 or the third electronic device 103). If the first electronic device 101 is connected with two or more electronic devices including a designated electronic device (e.g., the second electronic device 102 or the third electronic device 103), operation 815 may be performed, and if the connection is not established, a connection with one or more connectable fourth electronic devices may be attempted, or operation 813 may be repeated with a designated time interval, or the exemplary embodiment of FIG. 8B may end.

In operation 815, the first electronic device 101 may transmit data to the second electronic device 102. According to one exemplary embodiment, in a state where, upon reception of a ‘text message’, the first electronic device 101 is configured to transmit it to the second electronic device 102, if the ‘text message’ is received and a ‘missing call’ is acquired, the received ‘text message’ may be transmitted to the second electronic device 102. The second electronic device 102 which receives the ‘text message’ from the first electronic device 101 may display ‘text message’ reception information to a display module (not shown) of the second electronic device 102.

Select a data item for transmission to another electronic device. As discussed above, the data item may be a text message, a missed call notification, and/or any other suitable data item. The first electronic device 101 may determine whether it is connected to a predetermined number of other devices (e.g., two or more). The first electronic device 101 may be connected to each of the other devices via any suitable type of connection, such as a network connection, short-distance connection (e.g., Bluetooth), etc. In some implementations, if the first electronic device 101 is not connected to the predetermined number of other devices, the electronic device may actively attempt to establish connection with one or more devices. Additionally or alternatively, in some implementations, if the first electronic device 101 is not connected to the predetermined number of other devices, the electronic device may wait a predetermined time period and repeat operation 813. By contrast, if the first electronic device 101 is connected to the predetermined number of other devices, the process proceeds to operation 815. In operation 815, the first electronic device 101 transmits the data item to one of the devices, which the first electronic device is connected to.

When the first electronic device 101 performs operation 815, the exemplary embodiment of FIG. 8B may end.

Hereinafter, various exemplary embodiments of the present invention are described with reference to FIG. 8C.

FIG. 8C is a flowchart of an example of a process, according to aspects of the disclosure. In operation 821, the first electronic device 101 may execute media data included in data (e.g., SNS message information) received through a network communication, address information configured to execute the media data through the network communication, or media data included in the first electronic device 101 identify a media data item. For example, the media data item may include a screen configuration (e.g., a motion picture, music file, or a moving image) that can be displayed to one or more display modules, and may be data which may additionally include sound information a video file, and/or any other suitable type of media. In operation 823, the first electronic device 101 may determine whether it is connected to the second electronic device 102 and the third electronic device 103. The first electronic device may be connected to each of the other device via any suitable type of connection, such as a network connection, short-distance connection (e.g., Bluetooth), etc. In some implementations, if the first electronic device 101 is not connected to second electronic device 102 and the third electronic device 103, the first electronic device 101 may actively attempt to establish connection with the second and/or third electronic device. Additionally or alternatively, in some implementations, if the electronic device is not connected to the predetermined number of other devices, the electronic device may wait a predetermined time period and repeat operation 823. If the first electronic device is connected to the second and third electronic devices, the process proceeds to operation 825.

In operation 825, the first electronic device 101 displays the media data item on a display screen that is part of the first electronic device. In addition, the first electronic device 101 splits the media data item into a first portion and a second portion. Specifically, as discussed with respect to FIG. 6, the first electronic device 101 may divide each frame in the media data item into a first frame portion and a second frame portion. For example, the first frame portion may include the left half of each frame and the second frame portion may include the right half of each frame.

In operation, 827 the first electronic transmits the first data portion to the second electronic device and the second data portion to the third electronic device. In some implementations, the first electronic device may transmit the first portion of each frame in the media data item to the second electronic device while also transmitting the second portion of each frame in the media data item to the third electronic device. In some implementations, the first electronic device 101 may configure a screen such that the second media data and third media data received from the second electronic device 102 and third electronic device 103 are displayed to respective display modules as if they are one display module.

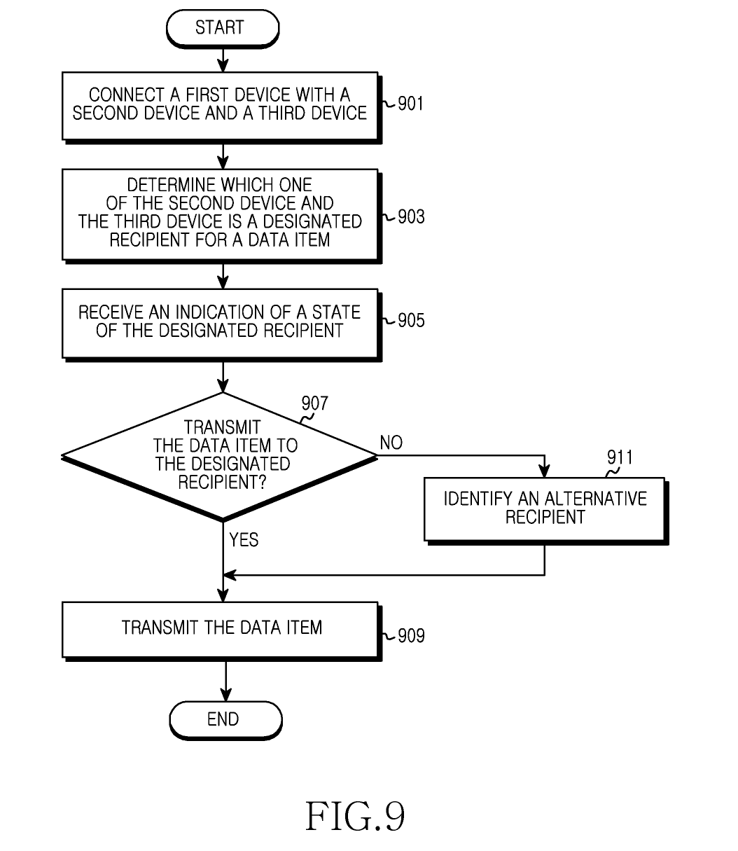

FIG. 9 is a flowchart of an example of a process, according to aspects of the disclosure. In operation 901, the first electronic device 101 may connect with the second electronic device 102 and third electronic device 103 (e.g., via a communications network). In operation 903, the first electronic device 101 may refer to configuration information stored in the memory 130 to determine which one of the second electronic device 102 and the third electronic device 103 is designated to receive a particular data item. In this example, the first electronic device 101 determines that the second electronic device 102 is designated to receive the data item. In operation 905, the first electronic device receives an indication of the state the electronic device designated to receive the data item (e.g., the second electronic device 102). In operation 907, the first electronic device 101 may determine whether to transmit the data item to the second electronic device 102 based on the state of the second electronic device's state information confirmed in operation 905. Upon a positive determination, the proceeds to operation 909 and the data item is transmitted to the second electronic device 102. By contrast, if the first electronic device 101 determines not to transmit the data, in operation 911, the electronic device identifies an alternative recipient for the data item and subsequently transmits the data item to the alternative recipient, at operation 909.

In operation 909, the first electronic device 101 may transmit the designated data to a fourth electronic device determined to transmit the data (e.g., the second electronic device if operation 909 is performed subsequently to operation 907, and another electronic device determined in operation 911 if operation 909 is performed subsequently to operation 911). The data transmitted by the first electronic device 101 to the fourth electronic device may be data (e.g., it may be one or more of data including a variety of information such as a ‘text message’, ‘call reception information’, ‘missing call information’, and ‘e-mail information’) received from a fifth electronic device (not shown) through a network communication, and may be transmitted to the fourth electronic device designated in configuration information according to a data attribute.

When the first electronic device 101 performs operation 909, the exemplary embodiment of FIG. 9 may end.

In operation 911, the first electronic device 101 may determine a next-priority electronic device capable of transmitting designated data (e.g., the third electronic device or another electronic device connected through a network communication). According to one exemplary embodiment, the first electronic device 101 may receive state information from the third electronic device or one or more different electronic devices connected with the first electronic device 101 through the network communication, and may determine whether designated data can be transmitted in an orderly manner from a next-priority electronic device of the second electronic device 102 configured to transmit data designated based on the configuration information of the first electronic device 101. When the electronic device capable of transmitting the designated data is determined, the first electronic device 101 may perform operation 909.

According to aspects of the disclosure, in a data processing method of the first electronic device, the method may include connecting the first electronic device with any one of a second electronic device and a third electronic device through a near distance communication, determining first data to be transmitted to the second electronic device and second data to be transmitted to the third electronic device respectively based on state information of the second electronic device and state information of the third electronic device, and transmitting the determined first data and second data respectively to the second electronic device and the third electronic device.

According to aspects of the disclosure, the first data and the second data may be data which is split such that data displayed to one screen in the first electronic device is displayed by using a plurality of screens of the second electronic device and the third electronic device.

According to aspects of the disclosure, the state information may contain at least one of battery remaining amount information of the second electronic device or the third electronic device, activation information, priority information, classification group information, connection state information of a near distance communication with the first electronic device, and data processing amount information.

According to aspects of the disclosure, the second data or the third data may be distinguished according to an attribute of data received by the first electronic device. According to aspects of the disclosure, the attribute of the data may contain at least one of call reception information, missing call information, received text message information, received e-mail information, received SNS message information, media information, alarm information, and a data type, and may be determined using two or more groups thereof.

According to aspects of the disclosure, the second electronic device and the third electronic device may be pre-designated to transmit one or more pieces of data received by the first electronic device from a fourth electronic device.

According to aspects of the disclosure, the near field wireless communication may be connected by using at least one of a WiFi communication, a BT communication, a NFC communication, a ZigBee communication, and an IrDA communication.

According to aspects of the disclosure, in a data processing method of the first electronic device, the method may include connecting a first electronic device with a second electronic device and a third electronic device through a near distance communication, determining not to transmit data designated to be transmitted to the second electronic device based on first state information of the second electronic device, and transmitting the designated data to the third electronic device based on second state information of the third electronic device.

According to aspects of the disclosure, in the determining of not to transmit the designated data, it may be determined not to transmit the data in a case where one or more pieces of numeric information included in the first state information does not satisfy designated numeric information.

According to aspects of the disclosure, the first state information and the second state information may include at least one of battery remaining amount information of the second electronic device or the third electronic device, activation information, priority information, classification group information, and connection state information of a near distance communication with the first electronic device.

According to aspects of the disclosure, although it is described that the electronic device 101 inserts one or more pieces of configuration information to the database, the present disclosure is not limited thereto. Thus, in some implementations, the information may be included in the data processing module 170.

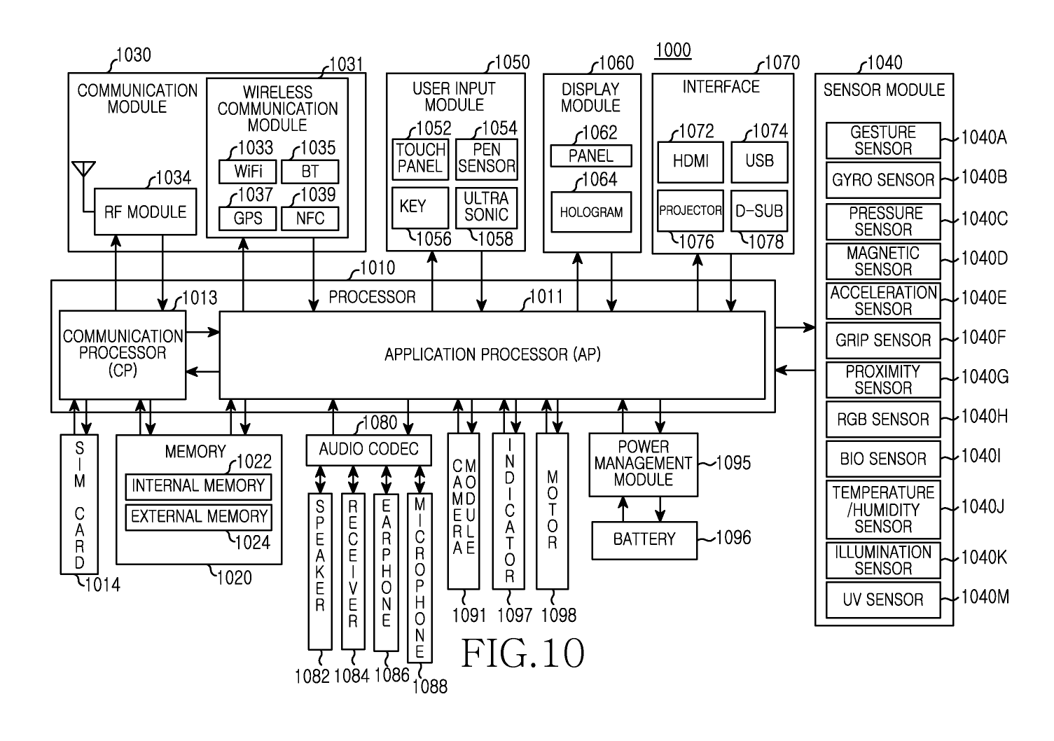

FIG. 10 illustrates a block diagram 1000 of an electronic device 1001 according to aspects of the disclosure. For example, the electronic device 1001 may constitute all or some parts of the electronic device 101 of FIG. 1. Referring to FIG. 10, the electronic device 1001 may include one or more processors 1010, a Subscriber Identification Module (SIM) card 1014, a memory 1020, a communication module 1030, a sensor module 1040, an input unit 1050, a display 1060, an interface 1070, an audio module 1080, a camera module 1091, a power management module 1095, a battery 1096, an indicator 1097, and a motor 1098.

In addition, the processor 1010 (e.g., the processor 120) may include one or more Application Processors (APs) 1011 or one or more Communication Processors (CPs) 1013. Although it is illustrated in FIG. 10 that the AP 1011 and the CP 1013 are included in the processor 1010, the AP 1011 and the CP 1013 may be included respectively in different Integrated Circuit (IC) packages. According to aspects of the disclosure, the AP 1011 and the CP 1013 may be included in one IC package.

The AP 1011 may control a plurality of hardware or software constitutional elements connected to the AP 1011 by driving an operating system or an application program, and may process a variety of data including multimedia data and may perform an arithmetic operation. The AP 1011 may be implemented, for example, with a System on Chip (SoC). According to aspects of the disclosure, the processor 1010 may further include a Graphic Processing Unit (GPU, not shown).

The CP 1013 may perform a function of managing a data link and changing a communication protocol in communication between different electronic devices (e.g., the electronic device 102, the electronic device 104, or the server 106) connected through a network with the electronic device 1001 (e.g., the electronic device 101) including hardware elements. Herein, the CP 1013 may be implemented with an SoC. According to aspects of the disclosure, the CP 1013 may perform at least a part of a multimedia control function. For example, the CP 1013 may identify and authenticate an electronic device in a communication network by using a subscriber identity module (e.g., the SIM card 1014). In this case, the CP 1013 may provide a service including a voice call, a video call, a text message, or packet data to a user.

Further, the CP 1013 may control data transmission/reception of the communication module 1030. Although constitutional elements such as the CP 1013, power management module 1095, the memory 1020, and the like are illustrated as separate constitutional elements with respect to the AP 1011 in FIG. 10, according to aspects of the disclosure, the AP 1011 may also be implemented such that at least one part (e.g., the CP 1013) of the aforementioned constitutional elements is included.

According to aspects of the disclosure, the AP 1011 or the CP 1013 may load an instruction or data, which is received from each non-volatile memory connected thereto or at least one of different constitutional elements, to a volatile memory and may process the instruction or data. In addition, the AP 1011 or the CP 1013 may store data, which is received from at least one of different constitutional elements or generated by at least one of different constitutional elements, into the non-volatile memory.

The SIM card 1014 may be a card which includes a SIM, and may be inserted to a slot formed at a specific location of the electronic device. The SIM card 1014 may include unique identification information (e.g., an Integrated Circuit Card IDentifier (ICCID)) or subscriber information (e.g., an International Mobile Subscriber Identity (IMSI)).

The memory 1020 (e.g., the memory 130) may include an internal memory 1022 or an external memory 1024. The internal memory 1022 may include, for example, at least one of a volatile memory (e.g., a Dynamic RAM (DRAM), a Static RAM (SRAM), a Synchronous Dynamic RAM (SDRAM), etc.) or a non-volatile memory (e.g., a One Time Programmable ROM (OTPROM), a Programmable ROM (PROM), an Erasable and Programmable ROM (EPROM), an Electrically Erasable and Programmable ROM (EEPROM), a Mask ROM, a Flash ROM, a NAND flash memory, a NOR flash memory, etc.). According to aspects of the disclosure, the internal memory 1022 may have a form of a Solid State Drive (SSD). The external memory 1024 may be a flash drive, and may further include, for example, Compact Flash (CF), Secure Digital (SD), Micro Secure Digital (Micro-SD), Mini Secure digital (Mini-SD), extreme Digital (xD), memory stick, and the like. The external memory 1024 may be operatively coupled to the electronic device 1001 via various interfaces. According to aspects of the disclosure, the electronic device 1001 may further include a storage unit (or a storage medium) such as a hard drive.

The communication module 1030 (e.g., the communication interface 160) may include a wireless communication module 1031 or a Radio Frequency (RF) module 1034. The wireless communication module 1031 may include, for example, a WiFi 1033, a BlueTooth (BT) 1035, a Global Positioning System (GPS) 1037, or a Near Field Communication (NFC) 1039. For example, the wireless communication module 1031 may provide a wireless communication function by using a radio frequency. Additionally or alternatively, the wireless communication module 1031 may include a network interface (e.g., a LAN card), modem, or the like for connecting the electronic device 1001 to a network (e.g., Internet, LAN, WAN, telecommunication network, cellular network, satellite network, POTS, etc.).

The RF module 1034 may serve to transmit/receive data, for example, to transmit/receive an RF signal. Although not shown, the RF module 1034 may include, for example, a transceiver, a Power Amp Module (PAM), a frequency filter, a Low Noise Amplifier (LNA), and the like. The RF module 1034 may further include a component for transmitting/receiving a radio wave on a free space in a wireless communication, for example, a conductor, a conducting wire, etc.

The sensor module 1040 may measure a physical quantity or detect an operation state of the electronic device 1001, and thus may convert the measured or detected information into an electric signal. The sensor module 1040 may include, for example, at least one of a gesture sensor 1040A, a gyro sensor 1040B, a pressure sensor 1040C, a magnetic sensor 1040D, an acceleration sensor 1040E, a grip sensor 1040F, a proximity sensor 1040G, a color sensor 1040H (e.g., a Red, Green, Blue (RGB) sensor), a bio sensor 1040I, a temperature/humidity sensor 1040J, an illumination sensor 1040K, and an Ultra Violet (UV) sensor 1040M. Additionally or alternatively, the sensor module 1040 may include, for example, an E-node sensor (not shown), an ElectroMyoGraphy (EMG) sensor (not shown), an ElectroEncephaloGram (EEG) sensor (not shown), an ElectroCardioGram (ECG) sensor (not shown), a fingerprint sensor (not shown), and the like. The sensor module 1040 may further include a control circuit for controlling at least one or more sensors included therein.

The input module 1050 may include a touch panel 1052, a (digital) pen sensor 1054, a key 1056, or an ultrasonic input unit 10510. The touch panel 1052 may recognize a touch input, for example, by using at least one of an electrostatic type, a pressure-sensitive type, and an ultrasonic type. The touch panel 1052 may further include a control circuit. In case of the electrostatic type, not only a physical contact but also a proximity recognition is possible. The touch panel 1052 may further include a tactile layer. In this case, the touch panel 1052 may provide the user with a tactile reaction.

The (digital) pen sensor 1054 may be implemented, for example, by using the same or similar method of receiving a touch input of the user or by using an additional sheet for recognition. The key 1056 may be, for example, a physical button, an optical key, a keypad, or a touch key. The ultrasonic input unit 10510 is a device by which a user equipment detects a sound wave through a microphone (e.g., a microphone 101010) by using a pen which generates an ultrasonic signal, and is a device capable of radio recognition. According to aspects of the disclosure, the electronic device 1001 may use the communication module 1030 to receive a user input from an external device (e.g., a network, a computer, or a server) connected thereto.

The display 1060 (e.g., the display 150) may include a panel 1062, a hologram 1064, or a projector 1066. The panel 1062 may be, for example, a Liquid-Crystal Display (LCD), an Active-Matrix Organic Light-Emitting Diode (AM-OLED), and the like. The panel 1062 may be implemented, for example, in a flexible, transparent, or wearable manner. The panel 1062 may be constructed as one module with the touch panel 1052. The hologram 1064 may use an interference of light and show a stereoscopic image in the air. The projector 1066 may display an image by projecting a light beam onto a screen. The screen may be located, for example, inside or outside the electronic device 1001. According to aspects of the disclosure, the display 1060 may further include a control circuit for controlling the panel 1062, the hologram 1064, or the projector 1066.

The interface 1070 may include, for example, a High-Definition Multimedia Interface (HDMI) 1072, a Universal Serial Bus (USB) 1074, an optical communication interface 1076, or a D-subminiature (D-sub) 1078. The interface 1070 may be included, for example, in the communication interface 160 of FIG. 1. Additionally or alternatively, the interface 1070 may include, for example, a Mobile High-definition Link (MHL) (not shown), a Secure Digital (SD)/Multi-Media Card (MMC) (not shown) or Infrared Data Association (IrDA) (not shown).

The audio module 1080 may bilaterally convert a sound and electronic signal. At least some constitutional elements of the audio module 1080 may be included in, for example, the input/output interface 140 of FIG. 1. The audio module 1080 may convert sound information which is input or output, for example, through a speaker 10102, a receiver 10104, an earphone 10106, the microphone 101010, and the like.

The camera module 1091 is a device for image and video capturing, and according to aspects of the disclosure, may include one or more image sensors (e.g., a front sensor or a rear sensor), a lens (not shown), an Image Signal Processor (ISP) (not shown), or a flash (not shown, e.g., LED or xenon lamp).

The power management module 1095 may manage a power of the electronic device 1001. Although not shown, the power management module 1095 may include, for example, a Power Management Integrated Circuit (PMIC), a charger Integrated Circuit (IC), or a battery fuel gauge.

The PMIC may be placed, for example, inside an IC or SoC semiconductor. Charging may be classified into wired charging and wireless charging. The charger IC may charge a battery, and may avoid an over-voltage or over-current flow from a charger. According to one aspects of the disclosure, the charger IC may further include a charger IC for at least one of the wired charging and the wireless charging. The wireless charging may be classified into, for example, a magnetic resonance type, a magnetic induction type, and an electromagnetic type. An additional circuit for the wireless charging, for example, a coil loop, a resonant circuit, a rectifier, and the like, may be added.

The battery gauge may measure, for example, a residual quantity of the battery 1096 and a voltage, current, and temperature during charging. The battery 1096 may store or generate an electricity, and may supply a power to the electronic device 1001 by using the stored or generated electricity. For example, the battery 1096 may include a rechargeable battery or a solar battery.

The indicator 1097 may indicate a specific state, for example, a booting state, a message state, a charging state, and the like, of the electronic device 1001 or a part thereof (e.g., the AP 1011). The motor 1098 may convert an electric signal into a mechanical vibration. Although not shown, the electronic device 1001 may include a processing unit (e.g., a GPU) for supporting a mobile TV. The processing unit for supporting the mobile TV may process media data according to a protocol of, for example, Digital Multimedia Broadcasting (DMB), Digital Video Broadcasting (DVB), media flow, and the like.

Each of the aforementioned constitutional element of the electronic device may consist of one or more components, and names of corresponding constitutional elements may vary depending on a type of electronic device. The electronic device according to aspects of the disclosure may include at least one of the aforementioned constitutional elements. Some of the constitutional elements may be omitted, or additional other constitutional elements may be further included. In addition, some of the constitutional elements of the electronic device according to aspects of the disclosure may be combined and constructed as one entity, so as to equally perform functions of corresponding constitutional elements before combination.

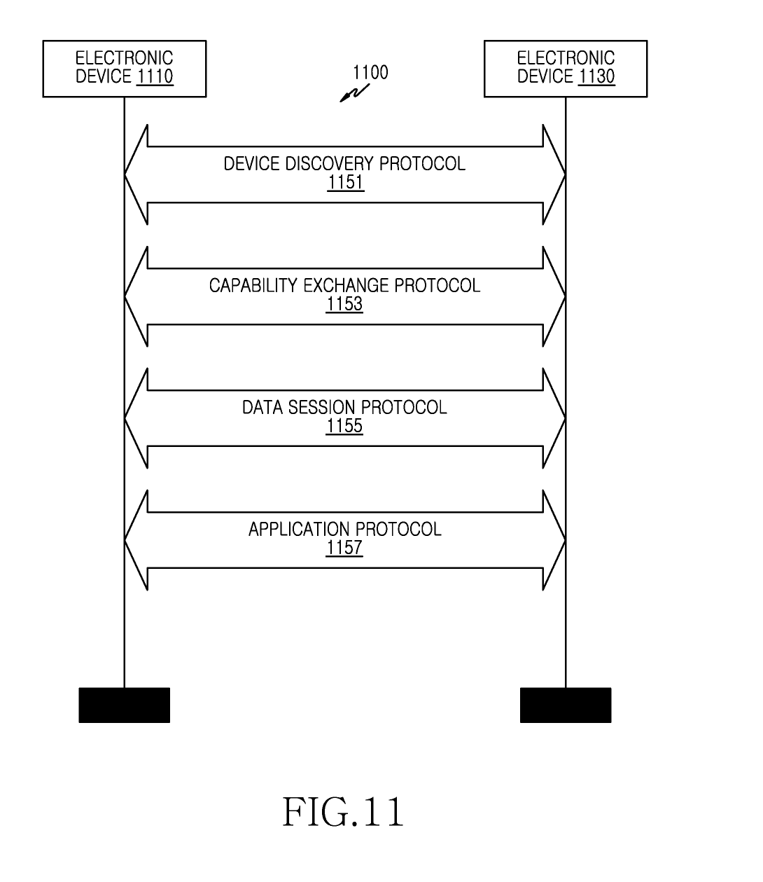

FIG. 11 illustrates a communication protocol 1100 among a plurality of electronic devices (e.g., an electronic device 1110 and an electronic device 1130) according to aspects of the disclosure. Referring to FIG. 11, for example, the communication protocol 1100 may include a device discovery protocol 1151, a capability exchange protocol 1153, a data session protocol 1155, an application protocol 1157, and the like.

According to aspects of the disclosure, the device discovery protocol 1151 may be a protocol by which electronic devices (e.g., the electronic device 1110 or the electronic device 1130) detect an external electronic device that can be connected with the electronic devices or connect with the detected external electronic device. For example, the electronic device 1110 (e.g., the electronic device 101) may use the device discovery protocol 1151 to detect the electronic device 1130 (e.g., the electronic device 102), as a device that can communicate with the electronic device 1110, through a communication method (e.g., WiFi, BT, USB, etc.) that can be used in the electronic device 1110. For a communication connection with the electronic device 1130, the electronic device 1110 may use the device discovery protocol 1151 to acquire and store identification information for the detected electronic device 1130. The electronic device 1110 may open a communication connection with the electronic device 1130 based on, for example, at least the identification information.

According to aspects of the disclosure, the device discovery protocol 1151 may be a protocol for performing a mutual authentication among a plurality of electronic devices. For example, the electronic device 1110 may perform the authentication between the electronic device 1110 and the electronic device 1130 based on communication information (e.g., MAC address, UUID, SSID, IPaddress) for a connection with at least the electronic device 1130.

According to aspects of the disclosure, the capability exchange protocol 1153 may be a protocol for exchanging information related to a function of a service that can be supported in at least one of the electronic device 1110 and the electronic device 1130. For example, the electronic device 1110 and the electronic device 1130 may use the capability exchange protocol 1153 to mutually exchange the information related to functions of services which are currently provided by the respective devices. Exchangeable information may include identification information for indicating a specific service among a plurality of services that can be supported by the electronic device 310 and the electronic device 320. For example, the electronic device 1110 may use the capability exchange protocol 1153 so that identification information of a specific service provided by the electronic device 1130 is received from the electronic device 1130. In this case, the first electronic device 1110 may determine whether the electronic device 1110 can support the specific service based on the received identification information.

According to aspects of the disclosure, the data session protocol 1155 may be a protocol for controlling a flow of data, for example, which is transmitted/received to provide a service in an interworking manner, between electronic devices (e.g., the electronic device 1110 and the electronic device 1130) connected to enable a communication. For example, at least one of the electronic device 1110 and the electronic device 1130 may use the data session protocol 1155 to perform an error control, a data quality control, and the like. Additionally or alternatively, the data session protocol 1155 may determine a transmission format of data transmitted/received between the electronic device 1110 and the electronic device 1130. In addition, at least one of the electronic device 1110 and the electronic device 1130 may use the data session protocol 1155 to manage at least a session for mutual data exchange (e.g., a session connection or a session termination).

According to aspects of the disclosure, the application protocol 1157 may be a procedure for exchanging data related to a service provided to an external electronic device or a protocol for providing information. For example, the electronic device 1110 (e.g., the electronic device 101) may provide the service to the electronic device 1130 (e.g., the electronic device 102, the electronic device 104, or the server 106) through the application protocol 1157.

According to aspects of the disclosure, the communication protocol 1100 may include a standard communication protocol, a communication protocol designated by an individual or an organization (e.g., a communication protocol designated autonomously by a communication device manufacturer, a network provider, etc.) or a combination thereof.

According to aspects of the disclosure, data processing method of an electronic device, comprising: connecting a first electronic device with any one of a second electronic device and a third electronic device through a near distance communication; determining first data to be transmitted to the second electronic device and second data to be transmitted to the third electronic device respectively based on state information of the second electronic device and state information of the third electronic device; and transmitting the determined first data and second data respectively to the second electronic device and the third electronic device. Wherein the first data and the second data are data which is split such that data displayed to one screen in the first electronic device is displayed by using a plurality of screens of the second electronic device and the third electronic device. Wherein the state information contains at least one of battery remaining amount information of the second electronic device or the third electronic device, activation information, priority information, classification group information, connection state information of a near distance communication with the first electronic device, and data processing amount information. Wherein the second data or the third data is identified according to an attribute of data received by the first electronic device. Wherein the attribute of the data contains at least one of call reception information, missing call information, received text message information, received e-mail information, received Social Networking Service (SNS) message information, media information, alarm information, and a data type, and is determined using two or more groups thereof. Wherein the second electronic device and the third electronic device are pre-designated to transmit one or more pieces of data received by the first electronic device from a fourth electronic device.

According to aspects of the disclosure, data processing method of an electronic device, comprising: connecting a first electronic device with a second electronic device and a third electronic device through a near distance communication; determining not to transmit data designated to be transmitted to the second electronic device based on first state information of the second electronic device; and transmitting the designated data to the third electronic device based on second state information of the third electronic device. Wherein the determining of not to transmit the designated data contains a case where one or more pieces of numeric information included in the first state information does not satisfy designated numeric information. Wherein the first state information and the second state information contain at least one of battery remaining amount information of the second electronic device or the third electronic device, activation information, priority information, classification group information, and connection state information of a near distance communication with the first electronic device.

The electronic device 101 may transmit data to another electronic device designated by a user or designated by being stored in configuration information. Therefore, it is possible to provide a user interface and a display method based on an attribute of data generated in the electronic device in a process of confirming user's data.

As used throughout the disclosure, the term “module” may refer to a unit including, for example, one of hardware, software, and firmware or a combination of two or more of them. The “module” may be interchangeably used with a term such as a unit, a logic, a logical block, a component, a circuit, and the like. The “module” may be a minimum unit of an integrally constituted component or may be a part thereof. The “module” may be a minimum unit for performing one or more functions or may be a part thereof. The “module” may be mechanically or electrically implemented. For example, the “module” may include at least one of an Application-Specific Integrated Circuit (ASIC) chip, a Field-Programmable Gate Arrays (FPGAs), and a programmable-logic device, which are known or will be developed and which perform certain operations.

According to aspects of the disclosure, at least some parts of a device (e.g., modules or functions thereof) or method (e.g., operations) disclosed in the claims and/or detailed description of the present disclosure may be implemented in hardware, software, or a combination of both. When implemented in software, computer-interpretable storage medium (or a computer-readable storage medium) for storing one or more programs (or programming modules) may be provided. For example, the software may be implemented with an instruction stored in a computer-readable storage medium in a programming module form. The one or more programs include processor-executable instructions.

In addition, the program may be stored in an attachable storage device capable of accessing the electronic device through a communication network such as the Internet, an Intranet, a Local Area Network (LAN), a Wide LAN (WLAN), or a Storage Area Network (SAN) or a communication network configured by combining the networks. The storage device may access an electronic device via an external port. Further, an additional storage device may access a portable electronic device on a communication network.

According to aspects of the disclosure, electronic device comprising: a memory configured to store one or more pieces of data configured to be transmitted to another electronic device; a communication interface configured to connect with a second electronic device and a third electronic device through a near distance communication; and one or more processors configured to determine first data to be transmitted to the second electronic device and/or second data to be transmitted to the third electronic device based on state information of the second electronic device and state information of the third electronic device, and configured to transmit the determined first data to the second electronic device and/or transmitting the second data to the third electronic device. Wherein the processor splits data into second data and third data such that data displayed to one screen in the first electronic device is displayed by using a plurality of screens of the second electronic device and the third electronic device. Wherein the processor receives the state information containing at least one of battery remaining amount information of the second electronic device or the third electronic device, activation information, priority information, classification group information, connection state information of a near distance communication with the first electronic device, and data processing amount information. Wherein the processor identifies the second data or the third data according to an attribute of data received by the first electronic device. Wherein the processor determines an attribute of the first data or an attribute of the second data by using two or more groups containing at least one of call reception information, missing call information, received text message information, received e-mail information, received SNS message information, media information, alarm information. Wherein the processor confirms a connection with the designated second electronic device and the designated third electronic device among a plurality of electronic devices designated to transmit one or more pieces of data received by the first electronic device from a fourth electronic device.

According to aspects of the disclosure, electronic device comprising: a memory configured to store one or more pieces of data configured to be transmitted to another electronic device; a communication interface configured to connect with a second electronic device and a third electronic device through a near distance communication; a processor configured to process not to transmit data designated to be transmitted to the second electronic device based on first state information of the second electronic device, and configured to transmit data designated based on second state information of the third electronic device to the third electronic device. Wherein the processor processes not to transmit the designated data if one or more pieces of numeric information contained in the first state information does not satisfy designated numeric information. Wherein the processor receives the first state information and/or second state information containing at least one of battery remaining amount information of each of the second electronic device or the third electronic device, activation information, priority information, classification group information, and connection state information of a near distance communication with the first electronic device.

FIGS. 1-11 are provided as an example only. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

What is claimed is:

1. A method of a first device comprising:
storing a first data item having an attribute;
identifying a second device that is designated to receive the first data item based on the attribute; and
transmitting at least a portion of the data item from the first device to the second device.

2. The method of claim 1, further comprising: receiving an indication of a state of the second device, wherein the data item is transmitted to the second device only when the state of the second device satisfies a predetermined criterion.

3. The method of claim 2, wherein the indication of the state of the second device indicates whether the second device is currently performing a media playback, and the predetermined criterion is satisfied when the second device is not performing a media playback.

4. The method of claim 2, wherein the indication of the state of the second device indicates a remaining battery power of the second device, and the predetermined criterion is satisfied when the remaining battery power exceeds a threshold amount.

5. The method of claim 2, further comprising:
identifying a third device as an alternative recipient that is designated to receive the first data item; and
transmitting the data item to the third device.

6. The method of claim 1, wherein the attribute of the data item includes a type of the data item, the type being selected from the group consisting of text message type, missed call notification type, activation information type, priority information type, and connection state information type.

7. The method of claim 1, wherein the data item includes a plurality of data item units, the method further comprising:
identifying, based on the attribute, a third device that is designated to receive the first data item; and
for each data item unit in the plurality, dividing the unit into a first portion and a second portion and transmitting the first portion to the second device and the second portion to the third device.

8. The method of claim 6, wherein the data item includes a video file and each data unit in the plurality includes a different frame.

9. The method of claim 1 further comprising, identifying a count of devices that are currently connected to the first device, wherein the data item is transmitted from the first device to the second device only when the count exceeds a threshold, the threshold being greater than or equal to two.

10. The method of claim 1, wherein the first device includes a smartphone and the second device includes a wearable device.

11. An electronic device comprising a memory and a controller configured to:
store, in the memory, a first data item having an attribute;
identify, based on the attribute, a first device that is designated to receive the first data item; and
transmit at least a portion of the data item to the first device.

12. The electronic device of claim 11, further comprising: receiving an indication of a state of the first device, wherein the data item is transmitted to the first device only when the state of the first device satisfies a predetermined criterion.

13. The electronic device of claim 12, wherein the indication of the state of the first device indicates whether the first device is currently performing a media playback, and the predetermined criterion is satisfied when the first device is not performing a media playback.

14. The electronic device of claim 12, wherein the indication of the state of the first device indicates a remaining battery power of the first device, and the predetermined criterion is satisfied when the remaining battery power exceeds a threshold amount.

15. The electronic device of claim 12, wherein the controller is further configured to:
identify a second device as an alternative recipient that is designated to receive the first data item; and
transmit the data item to the second device.

16. The electronic device of claim 11, wherein the attribute of the data item includes a type of the data item, the type being selected from the group consisting of text message type, missed call notification type, activation information type, priority information type, and connection state information type.

17. The electronic device of claim 11, wherein the data item includes a plurality of data item units and the controller is further configured:
identify, based on the attribute, a second device that is designated to receive the first data item; and
for each data item unit in the plurality, divide the unit into a first portion and a second portion and transmit the first portion to the first device and the second portion to the second device.

18. The electronic device of claim 16, wherein the data item includes a video file and each data unit in the plurality includes a different frame.

19. The electronic device of claim 11 wherein the controller is further configured to identify a count of devices that are currently connected to the electronic device, wherein the data item is transmitted to the first device only when the count exceeds a threshold, the threshold being greater than or equal to two.

20. The electronic device of claim 11, wherein the first device includes a smartphone and the first device includes a wearable device.
